(19) United States
(12) Patent Application Publication
(10) Pub. No.: US 2025/0163979 A1
(43) Pub. Date: May 22, 2025

(54) FRICTION RING WITH SECURING ELEMENTS FOR A TRACK WHEEL

(71) Applicant: Faiveley Transport Bochum GmbH, Bochum (DE)

(72) Inventors: Sebastian MONTUA, Bochum (DE); Norbert RADTKE, Bochum (DE); Lasse SCHULTE-FARWIG, Bochum (DE); Wolfgang BECKMANN, Bochum (DE)

(73) Assignee: Faiveley Transport Bochum GmbH, Bochum (DE)

(21) Appl. No.: 18/709,424

(22) PCT Filed: Nov. 3, 2022
(86) PCT No.: PCT/EP2022/080682

§ 371 Date: Jan. 21, 2025

(30) Foreign Application Priority Data
Nov. 10, 2021 (DE) 20 2021 106 132.4

(51) Int. Cl. F16D 65/12; F16D 65/02

(52) U.S. Cl. CPC F16D 65/124; F16D 65/121; F16D 65/128; F16D 2065/1312; F16D 2065/1332; F16D 2065/138

(57) ABSTRACT

In order to provide a track wheel, in particular a friction ring for a track wheel, which allows for effective cooling of a braking device of the track wheel, a friction ring (100) for a track wheel of a rail vehicle is proposed, comprising a friction side with a friction surface and a rear side (10) facing away from the friction side, wherein securing elements (11) are arranged on the rear side (10) protruding from the rear side (10), wherein the securing elements (11) have a substantially triangular shape when viewed from above, wherein it is provided that each of the securing elements (11) comprises a radial length R, wherein the friction ring (100) comprises an inner diameter Ri and an outer diameter Ra, and wherein R=0.30-0.90 (Ra-Ri).

The invention relates to a friction ring for a track wheel of a rail vehicle, a track wheel comprising such a friction ring, and a rail vehicle comprising such a track wheel.

Brake devices of rail vehicles usually comprise brake discs with at least one friction ring, which has a friction surface. The friction ring is attached to one side of the track wheel, in particular to a web of a track wheel. By actuating a brake cylinder, brake pads are applied to the friction surface of the friction ring, thereby generating a braking force.

There is often the problem that heat generated during the braking process must be dissipated to prevent the braking device from overheating. For this purpose, various cooling concepts are known from the prior art, which comprise cooling elements, for example, by means of which the heat generated during the braking process can be dissipated to the environment.

Although a certain cooling effect can be achieved with the cooling concepts known from the prior art, this is often insufficient and optimized cooling concepts are required which dissipate the generated heat more effectively.

The invention is therefore based on the task of providing a track wheel, in particular a friction ring for a track wheel, which allows for effective cooling of a braking device of the track wheel.

The problem according to the invention is solved by a friction ring for a track wheel of a rail vehicle, comprising a friction side with a friction surface and a rear side facing away from the friction side, wherein securing elements protruding from the rear side are arranged on the rear side, wherein the securing elements have an essentially triangular shape when viewed from above. Viewing the securing element from above here refers to a top view of the rear side of the friction ring or of an abutment surface of the securing element for abutment of the friction ring against the wheel web.

By means of the securing elements, the friction ring can be attached to a wheel web of the track wheel. In the secured state, the rear side of the friction ring faces the wheel web. As a result of the fact that a gap is formed between the rear side of the friction ring and the wheel web due to the securing elements arranged on the rear side, cooling air, in particular ambient air, can circulate advantageously in this gap. As a result, heat can be advantageously dissipated from the friction ring, in particular from the friction surface, via the rear side.

In order to optimize the flow of cooling air between the rear side of the friction ring with regard to improved heat dissipation, the securing elements have an essentially triangular shape when viewed in cross section parallel to the rear side. It has been shown that this shape of the securing elements makes it possible to achieve particularly effective circulation of cooling air between the rear side of the friction ring and the wheel web.

The term “essentially triangular shape” is to be understood in such a way that the securing elements do not have to have a strict triangular shape in the mathematical geometric sense. For example, the corners of the securing element do not necessarily have to be pointed or have a sharp edge, and the side surfaces of the securing element do not necessarily have to be flat or straight.

Preferably, the securing elements are arranged along a circumferential direction of the friction ring, in particular evenly spaced. In particular, the securing elements have the same angular spacing along the circumference.

Preferably, an even number of securing elements is provided, for example 4, 6, or 8. Alternatively, an odd number of securing elements may be provided, for example 3, 5, or 7 securing elements.

Preferably, each of the securing elements comprises three flank sides. The flank sides protrude from the rear side of the friction ring. The flank sides may be arranged substantially perpendicular to the rear side or may include an angle with a surface normal of the rear side. Such an angle may, for example, be provided by manufacturing and be between 6° and 10°, preferably between 7° and 9°, and most preferably 8°.

Preferably, a transition area between the three flank sides and the surface of the rear side of the friction ring is formed rounded or concave, preferably completely surrounding the securing element. This advantageously improves the circulation of the cooling air flow.

Preferably, the three flank portions are connected to one another by three corner portions, with at least one of the corner portions, preferably two of the corner portions, and very preferably all of the corner portions, being round. The round design of the corner portions further optimizes the circulation of the cooling air to advantage.

Preferably, at least one, preferably two, of the flank sides, in particular two inner flank sides, are formed convex. The inner flank sides are preferably those flank sides which are not aligned along the circumference of the friction ring and do not face an outer region of the friction ring. The convex shape refers, preferably exclusively, to a substantially radial or oblique radial direction of extension of the respective flank sides. Preferably, two flank sides have the same convex shape. The convex shape of the flank sides also ensures optimized cooling air circulation.

Preferably, a first, outer flank side is oriented along the circumference of the friction ring and perpendicular to a radial direction of the friction ring. Preferably, the first, outer flank side is flat or uncurved. Preferably, the securing elements are arranged and oriented on the rear side of the friction ring such that the securing elements have only one outer flank side and the other two flank sides are directed substantially inward. In this configuration, one of the corners of the triangular-shaped securing element points in the direction of a common intersection point, which need not be located in the center of the friction ring.

Preferably, each of the securing elements comprises a radial length R. The radial length R is preferably a shortest distance between the outer flank side, in particular at its center, and a corner area between the two inner flank sides, measured at an upper side or abutment surface of the securing element.

Preferably, the securing elements have a flat abutment surface on their upper side for abutting with the wheel web of the track wheel. The abutment surface is also preferably essentially triangular in shape.

Preferably, the friction ring comprises an inner diameter Rᵢ and an outer diameter Rₐ, where R=0.30-0.90 (Rₐ-Rᵢ), preferably R=0.50-0.70 (Rₐ-Rᵢ), particularly preferably R=0.55-0.65 (Rₐ-Rᵢ). These values result in an optimum size of the securing elements in relation to the friction ring so that, on the one hand, reliable securing is provided by a sufficiently large abutment surface between the wheel web and the respective securing elements and, at the same time, sufficient space is provided for circulation of the cooling air.

In addition, any combination of the above lower and upper limits may apply to the radial length R.

In particular, R=0.50-0.90 (Rₐ-Rᵢ), or R=0.55-0.90 (Rₐ-Rᵢ), or R=0.65-0.90 (Rₐ-Rᵢ), or R=0.70-0.90 (Rₐ-Rᵢ) may apply. Similarly, R=0.55-0.70 (Rₐ-Rᵢ), or R=0.65-0.70 (Rₐ-Rᵢ), or R=0.50-0.65 (Rₐ-Rᵢ) may apply.

Preferably, R is between 70 mm and 110 mm, more preferably between 80 mm and 100 mm, most preferably between 85 mm and 95 mm. For example, R can be 90 mm.

Preferably, the first flank side has a length l₁ as viewed in the circumferential direction of the friction ring, where l₁=0.40-0.60-R preferably l₁=0.45-0.55-R, particularly preferably l₁=0.40-0.50-R. The length l₁ of the first flank sides is preferably a maximum length of a straight or flat section of the first flank side.

Preferably, l₁ is between 30 mm and 60 mm, more preferably between 35 mm and 55 mm, most preferably between 40 mm and 50 mm. For example, l₁ can be 45 mm.

Preferably, a radius of curvature r₂ of a first and a second corner portion between a first, outer flank side on the one hand and a second, inner flank side and a third, inner flank side on the other hand is r₂=0.15-0.29-R, preferably r₂=0.17-0.27-R, whole particularly preferred r₂=0.20-0.24-R.

Preferably, r₂ is between 10 mm and 35 mm, more preferably between 12 mm and 30 mm, most preferably between 15 mm and 25 mm. For example, r₂ can be 20 mm.

Preferably, a radius of curvature r₄ of a third corner portion between a second, inner and a third, inner flank side is r₄=0.10-0.28-R, preferably r₄=0.14-0.24-R, most preferably r₄=0.18-0.20-R.

Preferably, r₄ is between 10 mm and 30 mm, more preferably between 12 mm and 25 mm, most preferably between 15 mm and 20 mm. For example, r₄ can be 17 mm. Preferably, a radius of curvature r₃ of each of the convex flank sides is r₃=0.5-1.00-R, preferably r₃=0.7-0.8 R, most preferably r₃=0.72-0.75-R.

Preferably, r₃ is between 55 mm and 80 mm, more preferably between 60 mm and 75 mm, most preferably between 65 mm and 70 mm. For example, r₃ can be 67 mm.

The parameters described above result in a geometry of the securing elements that enables particularly effective circulation of cooling air. This advantageously improves the dissipation of heat.

Advantageously, the securing elements themselves can also contribute to the cooling of the friction ring due to their shape by releasing heat via the securing elements.

Preferably, at least one, preferably two, most preferably three, preferably radial centering grooves are arranged in the rear side. Preferably, sliding blocks can be inserted into the centering grooves, wherein the centering grooves serve to guide the sliding blocks. The sliding blocks serve to center the friction ring during thermal expansion. Preferably, the centering grooves are evenly spaced along the circumference of the friction ring.

Preferably, at least one cooling element, in particular a cooling fin extending preferably radially outward, is arranged on the rear side. Preferably, one cooling element each is arranged between two securing elements. Preferably, a height of the at least one cooling element is smaller than or equal to the height of the securing elements relative to the surface of the rear side of the friction ring.

Preferably, the at least one cooling element, in particular in the embodiment as a cooling fin, may have a straight or a curved shape in a top view.

Preferably, at least one circulation element, in particular of round design, is arranged on the rear side. The circulation elements serve to optimize the course of the cooling air flow between the rear side of the friction ring and the wheel web and thus further improve the cooling performance. Preferably, several circulation elements are arranged symmetrically on the friction ring. Preferably, a first row of circulation elements is arranged along an outer edge portion of the rear side and a second row of circulation elements is arranged along an inner edge portion of the rear side. Preferably, circulation elements are arranged between the securing elements, respectively. Preferably, circulation elements are arranged next to, in particular on both sides next to, one cooling element, respectively. The at least one circulation element can be, for example, a round pin which protrudes from the surface of the rear side of the friction ring. Preferably, a height of the at least one circulation element is smaller than or equal to the height of the securing elements relative to the surface of the rear side of the friction ring.

Preferably, each securing element is associated with at least one cooling element and/or at least one circulation element. Preferably, the securing element, the at least one cooling element and/or the at least one circulation element thus form a group of elements, wherein such a group is arranged repeatedly over the circumference of the friction ring.

Preferably, the friction ring comprises several friction ring segments. Preferably, the friction ring segments have the same size. Preferably, the securing elements are distributed evenly over the friction ring segments. Preferably, the friction ring segments are connected to one another by means of connecting elements, in particular by means of connecting bolts.

Preferably, at least one of the securing elements comprises a through hole through the friction ring or a blind hole. The through hole or blind hole is used for securing, in particular for screwing, the friction ring to the wheel web.

Preferably, each of the securing elements comprises a through hole through the friction ring or a blind hole, whereby securing elements with a through hole and a blind hole alternate as viewed in the circumferential direction of the friction ring. Preferably, two friction rings can be arranged on opposite sides of the track wheel, preferably in such a way that a securing element with a blind hole is opposite a securing element with a through hole. This allows a securing element, for example a threaded screw, to be advantageously guided through the through hole of the first friction disk into the blind hole of the second friction ring and secured or screwed there.

The task according to the invention is further solved by a track wheel having at least one, preferably two, friction ring(s) with the features described above.

Furthermore, the task according to the invention is solved by a rail vehicle having a track wheel described above.

The invention is explained in more detail below with reference to examples of embodiments. The figures show the following:

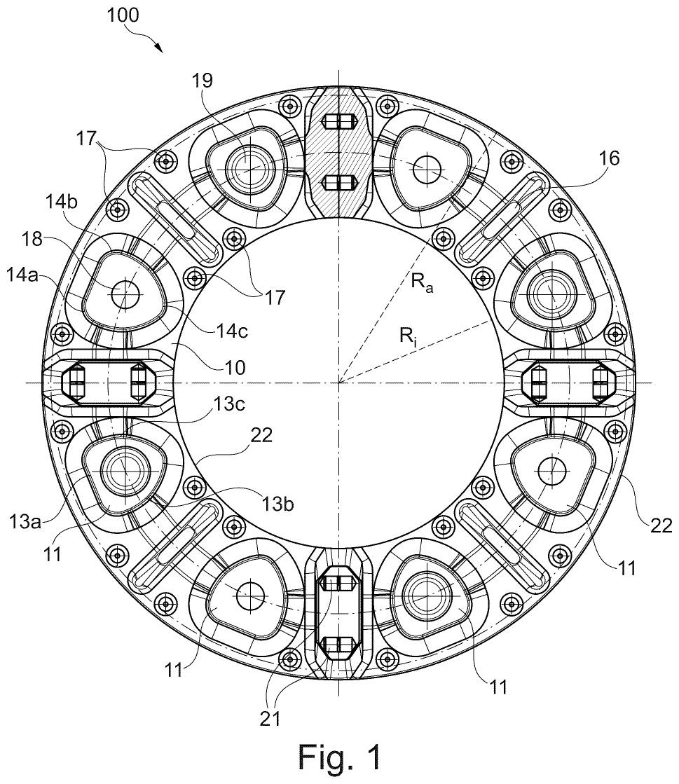

FIG. 1 shows a top view of a friction ring with securing elements,

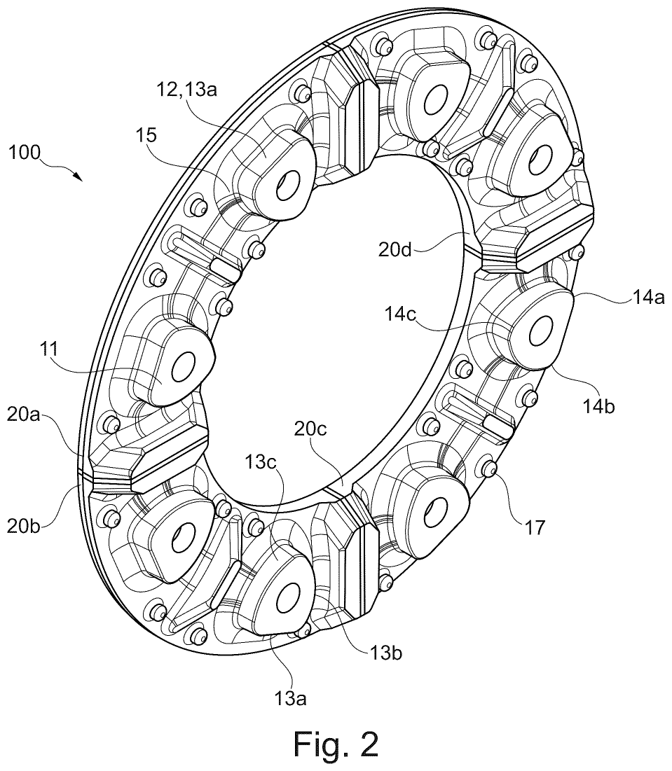

FIG. 2 shows a perspective view of the friction ring,

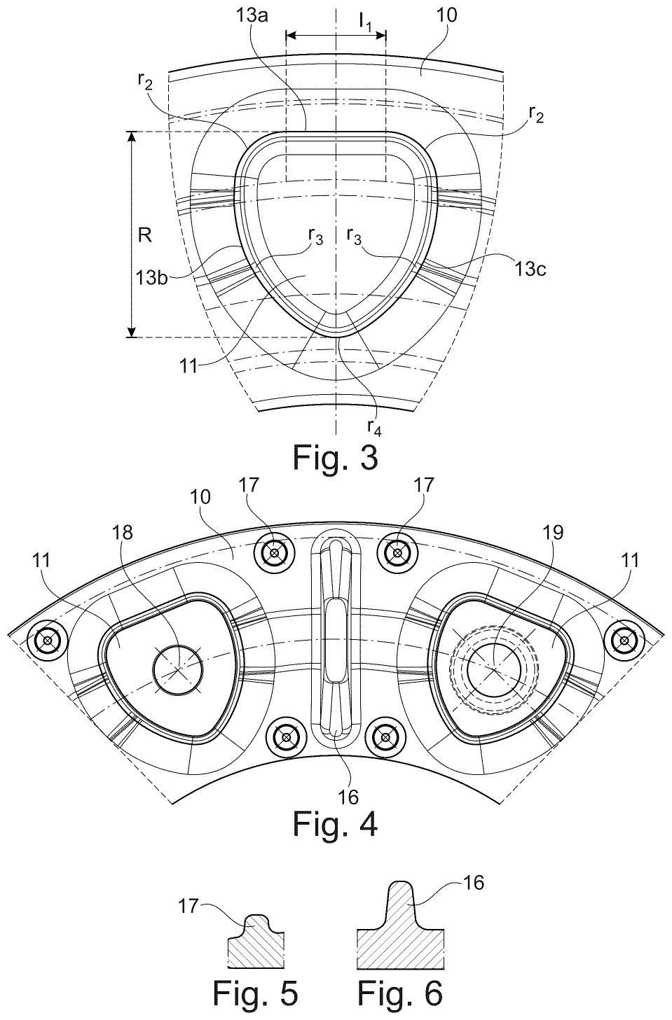

FIG. 3a shows a sectional top view of a securing element,

FIG. 4 shows a sectional top view of two securing elements as well as a cooling fin and circulation elements,

FIG. 5 shows a cross-sectional view through a circulation element, and

FIG. 6 shows a cross-sectional view through the cooling fin.

FIG. 1 shows a friction ring 100 in a plan view. The friction ring 100 has a friction side not shown here and a rear side 10 facing away from the friction side. Furthermore, the friction ring has an inner diameter Rᵢ and an outer diameter Rₐ. Eight securing elements 11 are arranged on the rear side 10, wherein the securing elements arranged evenly spaced along the circumference of the friction ring 100. The securing elements 11 have a triangular basic shape. In particular, an abutment surface, which is formed as a plateau, has a triangular basic shape.

The securing elements 11 are each formed of the same design. Each securing element 11 has a flank surface 12 which extends along a circumference of the securing element 11. Furthermore, the securing element 11 has a first flank side 13a, a second flank side 13b, and a third flank side 13c. The first flank portion 13a is substantially planar in shape and is oriented along an outer periphery of the friction ring 100. Thus, a surface normal of the first flank side 13a extends along a radial extent of the friction ring 100.

The two other flank sides 13b and 13c are formed convex. The flank sides 13b and 13c are arranged to extend substantially from an outer periphery to an inner periphery of the friction ring 100. The securing element 11 further has a first corner portion 14a, a second corner portion 14b, and a third corner portion 14c. The corner portions 14a, 14b, 14c are formed rounded. The first corner portion 14a and the second corner portion 14b have the same radius of curvature r₂ and are arranged facing the outer circumferential surface of the friction ring 100. The third corner portion 14c has a radius of curvature r₄ that is different, in particular smaller, than the radius of curvature r₂ of the first corner portion and the second corner portion, respectively. The third corner portion 14c is arranged facing an inner circumferential surface of the friction ring 100 and is oriented toward a center of the friction ring 100.

Furthermore, the friction ring 100 has cooling elements 16 in the form of cooling fins as well as circulation elements 17, which will be described in more detail below.

Each of the securing elements 11 has either a through hole 18 or a blind hole 19. As shown in FIGS. 1 and 2, securing elements 11 with a blind hole 19 and securing elements 11 with a through hole 18 alternate. As a result, two friction rings 100 on a track wheel can advantageously be arranged opposite each other on two sides of the wheel web and alternately fastened in such a way that a securing element 11 with a through hole 18 of a first friction ring 100 is opposite a securing element 11 with a blind hole 19 of a second friction ring 100 in order to guide a securing element through the through hole 18 into the blind hole 19.

FIG. 2 shows the friction ring 100 in a perspective view. In particular, the flank sides 13a, 13b, 13c can be seen. It can also be seen that a transition portion 15 between the flank surface or flank sides 13a, 13b,13c and the corner portions 14a, 14b, 14c on the one hand and the rear side 10 of the friction ring 100 on the other hand is formed rounded or concave along a circumference of the securing element 11.

In FIG. 2, it can further be seen that the friction ring 100 is composed of friction ring segments. In the embodiment shown here, the friction ring 100 is composed of four friction ring segments 20a, 20b, 20c, 20d. The friction ring segments 20a, 20b, 20c, 20d are connected to each other by means of connecting bolts not shown here. The friction ring segments 20a, 20b, 20c, 20d are formed substantially in the same way. Each of the friction ring segments 20a, 20b, 20c, 20d has two securing elements 11.

FIG. 3 shows a detailed view of a securing element 11. The three flank sides 13a, 13b, 13c and the three corner portions 14a, 14b, 14c, which connect the flank sides 13a, 13b, 13c to one another, can be seen. The flank sides 13a, 13b, 13c have a flat or a convex shape, each of which merges into the rounded shape of the corner portions 14a, 14b, 14c.

The securing element has a radial length R, which may be 90 mm, for example. The radii of curvature r₂ of the outer, first and second corner portions 14, 14b can be 20 mm, for example. The radius of curvature r₄ of the inner, third corner portion 14c can be 17 mm, for example.

The first flank side 13a is formed flat and has a length l₁, which can be 45 mm, for example. The length l₁ is the section of the first flank side 13a between the first and second corner portions 14a, 14b, which is straight or flat, respectively. The two remaining flank sides 13b, 13c are each formed convex with the same radius of curvature r₃, where r₃ can be 67 mm, for example. The flank sides 13a, 13b, 13c run obliquely and include an angle with the surface normal of the rear side 11 of the friction ring 100. This angle may be 8°, for example.

In FIG. 4, a sectional top view of two securing elements 11 of the friction ring 100 is shown. A cooling element 16 is arranged between the two securing elements 11. The cooling element 16 is configured as a cooling fin which extends in a radial direction. The cooling fin has a height which does not exceed the height of the securing elements 11. The cooling fin has a substantially trapezoidal shape. Circulation elements 17 are arranged laterally next to the cooling element 16. In each case, two circulation elements 17 are arranged between the cooling element 16 and one of the securing elements 11. In each case, circulation elements 17 are arranged in a portion of the outer circumference 22 and in a portion of the inner circumference 23 of the friction ring 100.

FIG. 5 shows a cross-section through a circulation element 17. The circulation element 17 has the shape of a round pin, the upper side of which has a rounded, circumferential edge or crest. FIG. 6 shows a cross-section through the cooling element 16. The cooling element 16 has obliquely extending flanks and also an upper side with rounded, radially extending edges. Both the circulation element 17 and the cooling element 16 have a rounded or concave transition region between the flank surfaces of the respective elements and the rear side 12 of the friction ring 100.

### LIST OF REFERENCE SIGNS

100 friction ring
10 rear side of the friction ring
11 securing element
12 flank surface
13a first flank side
13b second flank side
13c third flank side
14a first corner portion
14b second corner portion
14c third corner portion
l₁ length of the first flank portion
r₂ radius of curvature of the first and second corner portion
r₃ radius of curvature of the first and/or the second flank portions
r₄ radius of curvature of the third corner portion
R radial length of the securing element
Rᵢ inner diameter of the friction ring
Rₐ outer diameter of the friction ring
15 transition portion
16 cooling element
17 circulation element
18 through hole
19 blind hole
20a, 20b,
20c, 20d friction ring segments

1. Friction ring for a track wheel of a rail vehicle, comprising a friction side with a friction surface and a rear side facing away from the friction side, wherein securing elements projecting from the rear side are arranged on the rear side (10), wherein the securing elements have a substantially triangular shape when viewed from above, wherein each of the securing elements comprises a radial length R, wherein the friction ring comprises an inner diameter Rᵢ and an outer diameter Rₐ, and wherein R=0.30-0.90 (Rₐ-Rᵢ).

2. Friction ring according to claim 1, wherein the securing elements are arranged evenly spaced along a circumferential direction of the friction ring, in particular evenly spaced.

3. Friction ring according to claim 1, wherein each of the securing elements comprises three flank sides wherein the three flank sides are connected to one another by three corner portions, wherein all of the corner portions are formed round.

4. (canceled)

5. Friction ring according to claim 3, wherein at least two inner flank sides, are formed convex.

6. Friction ring according to claim 3, wherein a first, outer flank side is oriented along the circumference of the friction ring and perpendicular to a radial direction.

7. Friction ring according to claim 6, wherein the first, outer flank side is formed flat.

8. Friction ring according to claim 1, wherein R=0.50-0.70 (Rₐ-Rᵢ), or wherein R=0.55-0.65 (Rₐ-Rᵢ).

9. Friction ring according to claim 6, wherein the first flank side has a length l₁ as viewed in the circumferential direction of the friction ring, wherein |1=0.40-0.60-R or l₁=0.45-0.55-R, or l₁=0.40-0.50-R.

10. Friction ring according to claim 3, wherein for a radius of curvature r₂ of a first and a second corner portion respectively between a first, outer flank side on the one hand and a second, inner flank side and a third, inner flank side on the other hand the following applies: r₂=0.15-0.29-R, or r₂=0.17-0.27-R, or r₂=0.20-0.24-R.

11. Friction ring according to claim 3, wherein for a radius of curvature r₄ of a third corner portion between a second, inner and a third, inner flank side the following applies: r₄=0.10-0.28-R, or r₄=0.14-0.24-R, or r₄=0.18-0.20-R.

12. Friction ring according to claim 5, wherein for a radius of curvature r₃ of each of the convex flank sides the following applies: r₃=0.5-1.00-R, or r₃=0.7-0.8 R, or r₃=0.72-0.75-R.

13. Friction ring according to claim 1, wherein at least three, radial centering grooves are arranged in the rear side.

14. Friction ring according to claim 1, wherein at least one cooling fin extending radially outwards is arranged on the rear side and/or wherein at least one circulation element, which is formed round, is arranged on the rear side.

15. (canceled)

16. Friction ring according to claim 1, wherein the at least one cooling element and/or the at least one circulation element, is associated with each securing element.

17. Friction ring according to claim 1, wherein the friction ring comprises several friction ring segments.

18. Friction ring according to claim 17, wherein the friction ring segments are connected to one another by means of connecting bolts.

19. Friction ring according to claim 1, wherein at least one of the securing elements comprises a through hole through the friction ring or a blind hole.

20. Friction ring according to claim 19, wherein each of the securing elements comprises a through hole through the friction ring or a blind hole (19), and wherein securing elements with a through hole (18) and a blind hole (19) alternate as viewed in the circumferential direction of the friction ring.

21. Track wheel of a rail vehicle, having at least two friction rings according to claim 1.

22. Rail vehicle having at least one track wheel according to claim 21.
